(19) United States
(12) Patent Application Publication
(10) Pub. No.: US 2014/0089695 A1
(43) Pub. Date: Mar. 27, 2014

(54) ENERGY-SAVING DEVICE

(71) Applicant: MSI COMPUTER(SHENZHEN)CO., LTD., Shenzhen City (CN)

(72) Inventors: Chi-Hsien Yu, New Taipei City (TW); Chun-Huang Kuo, New Taipei City (TW)

(73) Assignee: MSI COMPUTER(SHENZHEN)CO., LTD., Shenzhen City (CN)

(21) Appl. No.: 13/771,103

(22) Filed: Feb. 20, 2013

(30) Foreign Application Priority Data
Sep. 25, 2012 (TW) 101135022

(51) Int. Cl. G06F 1/32

(52) U.S. Cl. CPC G06F 1/3234
USPC 713/320

(57) ABSTRACT

The present invention discloses an energy-saving device with multiple voltage levels which is applied to a motherboard. The energy-saving device includes an energy-saving driving module electrically connected to a CPU on the motherboard for generating an energy-saving signal with multiple voltage levels to the CPU, so as to switch the CPU to a corresponding operational frequency according to a voltage level of the energy-saving signal after the CPU receives the energy-saving signal. The energy-saving device with multiple voltage levels implements 256 voltage levels instead of the conventional two voltage levels, so as to achieve multiple power consumption of the motherboard.

### BACKGROUND OF THE INVENTION

1. Field of the Invention

The present invention relates to a circuit device for a motherboard, and more specifically, to a circuit device capable of saving electrical energy for a motherboard.

2. Description of the Prior Art

As a PROCHOT# pin of a CPU on a conventional motherboard is defined as an input pin, a PROCHOT# signal can be driven by external circuits for underclocking the CPU, so as to decrease power consumption. However, the conventional PROCHOT# signal only has two kinds of levels, a high level or a low level. In general operation, as a temperature of the CPU rises to a predetermined value, a Super Input/Output (SIO) chip pulls down the PROCHOT# signal to the low level to switch the CPU to divide frequency, so as to decrease the temperature of the CPU. However, a method for saving electrical energy is only to switch the PROCHOT# signal between the high level and low level. As a result, there is a need to develop an energy-saving device for the motherboard to improve a disadvantage of the conventional motherboard described above.

### SUMMARY OF THE INVENTION

A purpose of the present invention is to provide an energy-saving device with multiple voltage levels capable of implementing 256 voltage levels instead of the conventional two voltage levels, so as to achieve multiple power consumption of the motherboard.

In order to achieve the purpose of the present invention, the present invention is to provide the energy-saving device with multiple voltage levels which is applied to a motherboard. The energy-saving device includes an energy-saving driving module electrically connected to a CPU on the motherboard for generating an energy-saving signal with multiple voltage levels to the CPU, so as to switch the CPU to a corresponding operational frequency according to a voltage level of the energy-saving signal after the CPU receives the energy-saving signal.

The present invention is to provide the energy-saving device with multiple voltage levels, such as being capable of implementing 256 voltage levels instead of the conventional two voltage levels, so as to achieve multiple power consumption of the motherboard. A purpose of implementing multiple voltage levels can be achieved by the PWM, so as to achieve different power consumption. In addition, the energy-saving device can be applied to a desktop computer, a notebook computer, a tablet computer or other computer device, so as to decrease the power consumption.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram of an energy-saving device according to an embodiment of the present invention.

FIG. 2 to FIG. 4 are different waveform diagrams of an energy-saving signal according to the embodiment of the present invention.

FIG. 5 is a block diagram of an energy-saving driving module according to the embodiment of the present invention.

FIG. 6 is a block diagram of the energy-saving driving module according to another embodiment of the present invention.

FIG. 7 is a circuit diagram of the energy-saving driving module illustrated in FIG. 5 according to the embodiment of the present invention.

FIG. 8 is a circuit diagram of the energy-saving driving module illustrated in FIG. 6 according to another embodiment of the present invention.

FIG. 9 is a block diagram of the energy-saving driving module according to another embodiment of the present invention.

FIG. 10 is a flowchart showing the operation of the energy-saving device according to the embodiment of the present invention.

FIG. 11 is a block diagram of the energy-saving device according to another embodiment of the present invention.

FIG. 12 is a circuit diagram of a power meter illustrated in FIG. 11 according to another embodiment of the present invention.

FIG. 13 is a flowchart showing another operation of the energy-saving device according to the embodiment of the present invention.

FIG. 14 is a flowchart showing another operation of the energy-saving device according to the embodiment of the present invention.

### DETAILED DESCRIPTION

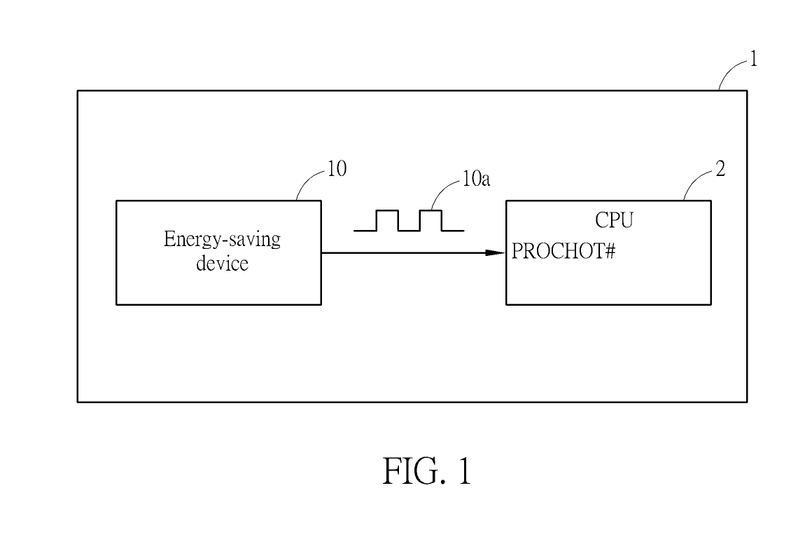

Please refer to FIG. 1. FIG. 1 is a block diagram of an energy-saving device 10 according to an embodiment of the present invention. The energy-saving device 10 can be applied to a motherboard 1 for decreasing power consumption of a CPU 2. For example, the energy-saving device 10 can be applied to a desktop computer, a notebook computer, a tablet computer or other computer device with the motherboard 1. In order to make the characteristics of the invention easier to understand, only related hardware components are illustrated on the motherboard 1, and the other hardware components which are not directly related to the present invention are omitted. In this embodiment, it can utilize the CPU 2 with a divide function for decreasing the power consumption and the energy-saving device 10 to implement an energy-saving signal 10a with 256 voltage levels instead of the conventional two voltage levels. A preferred example of the energy-saving signal 10a is a PROCHOT# signal which is output to a PROCHOT# pin of the CPU 2.

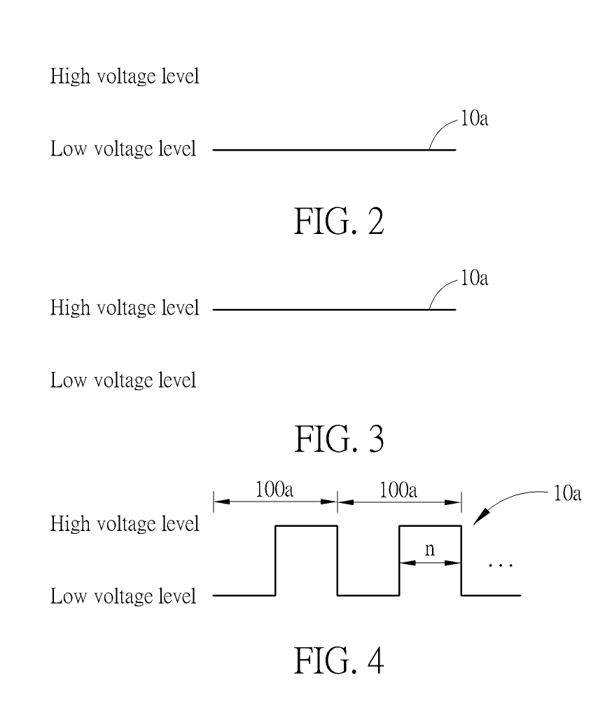

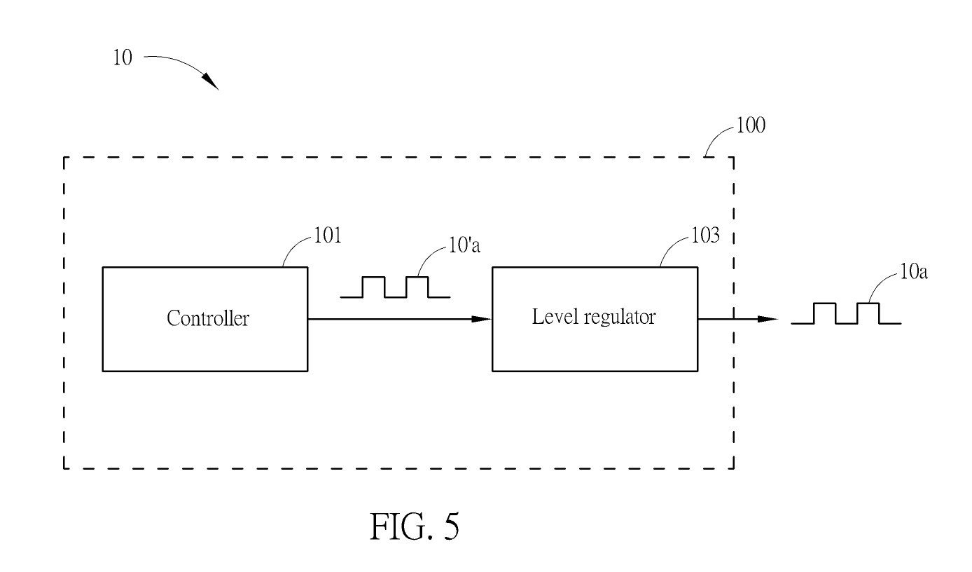

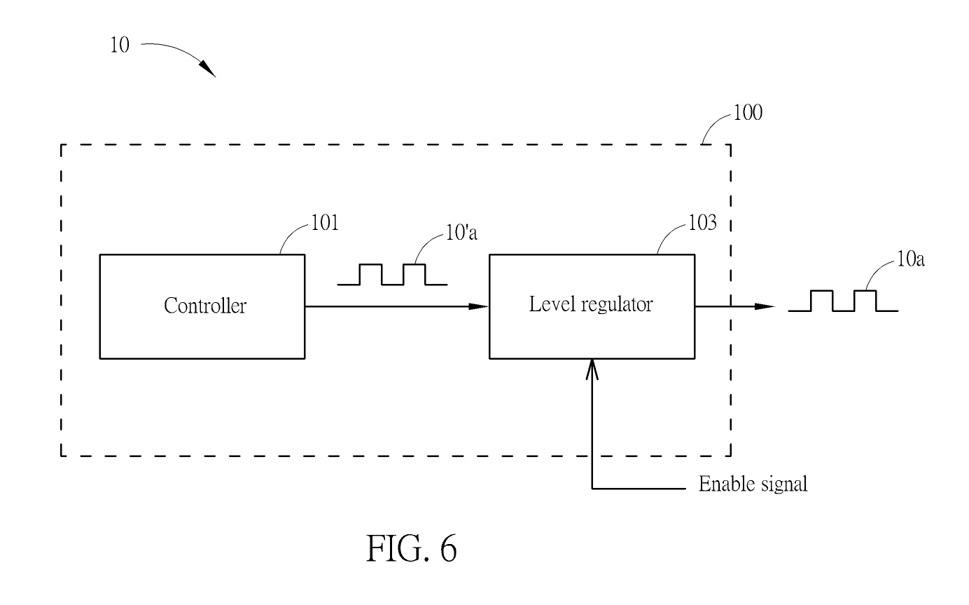

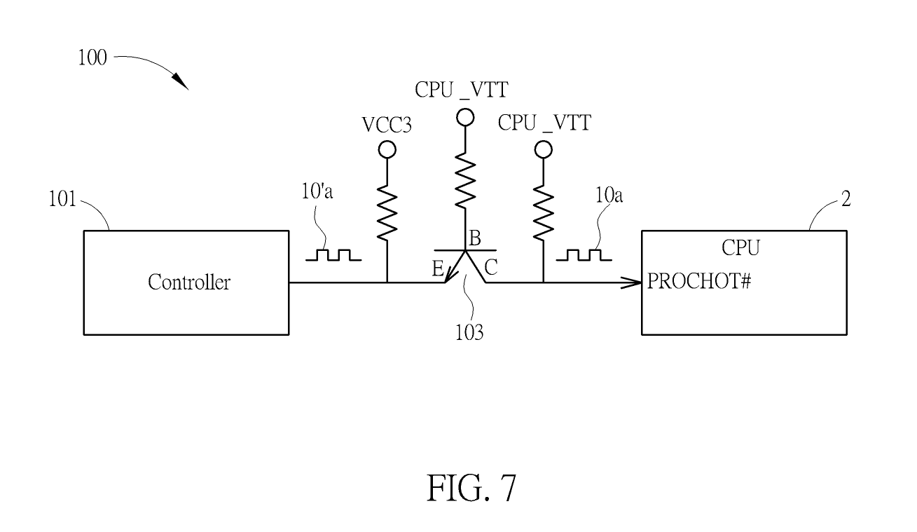

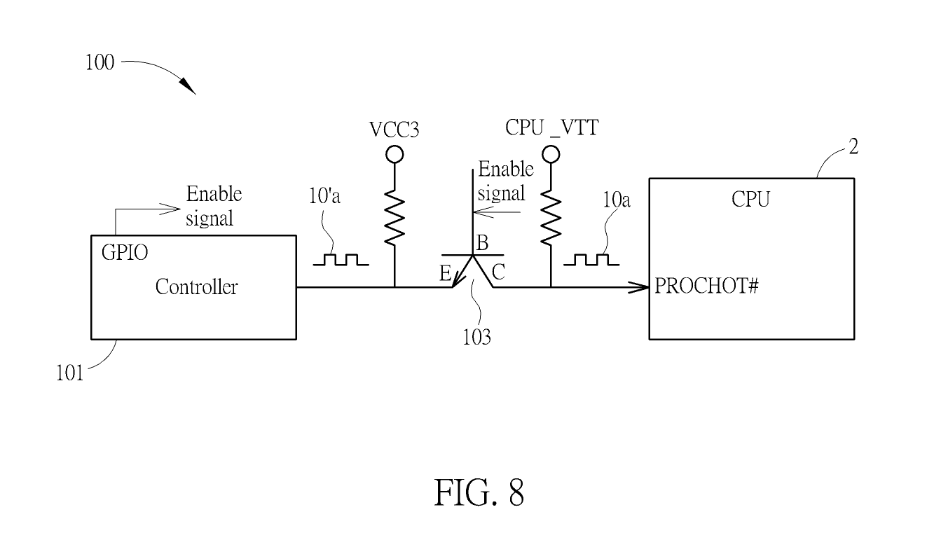

Please refer to FIG. 1 to FIG. 8. FIG. 2 to FIG. 4 are different waveform diagrams of the energy-saving signal 10a according to the embodiment of the present invention. FIG. 5 is a block diagram of an energy-saving driving module 100 according to the embodiment of the present invention. FIG. 6 is a block diagram of the energy-saving driving module 100 according to another embodiment of the present invention. FIG. 7 is a circuit diagram of the energy-saving driving module 100 illustrated in FIG. 5 according to the embodiment of the present invention. FIG. 8 is a circuit diagram of the energy-saving driving module 100 illustrated in FIG. 6 according to another embodiment of the present invention. The energy-saving device 10 includes the energy-saving driving module 100 electrically connected to the CPU 2 on the motherboard 1 for generating the energy-saving signal 10a with multiple voltage levels to the PROCHOT# pin of the CPU, so as to switch the CPU 2 to a corresponding operational frequency according to a voltage level of the energy-saving signal 10a after the CPU 2 receives the energy-saving signal 10a. That is, as the energy-saving signal 10a is a high voltage level signal, the CPU 2 operates in a high operational frequency. On the contrary, as the energy-saving signal 10a is a low voltage level signal, the CPU 2 operates in a low operational frequency.

Please refer to FIG. 2 to FIG. 4. The energy-saving signal 10a generated by the energy-saving driving module 100 can be a variable digital signal. As shown in FIG. 2, the energy-saving signal 10a is the low voltage level signal. As the CPU 2 receives the energy-saving signal 10a in FIG. 2, the CPU 2 operates in the low operational frequency in duration of the energy-saving signal 10a, so that the motherboard 1 can achieve maximum energy saving. As shown in FIG. 3, the energy-saving signal 10a is the high voltage level signal. As the CPU 2 receives the energy-saving signal 10a in FIG. 3, the CPU 2 operates in the high operational frequency in the duration of the energy-saving signal 10a, so that the CPU 2 is desired to compute with high performance, regardless of power consumption.

The energy-saving signal 10a in FIG. 4 is a signal composed of continuous square waves 100a. A value of n in FIG. 4 is an integer between 0 and 255. That is, the energy-saving signal 10a can be the single square wave 100a. A ratio of the high voltage level of the square wave 100a to a low voltage level of the square wave 100a is determined by the n. As the value of n is 255, the energy-saving signal 10a is the high voltage level signal. As the value of n is 0, the energy-saving signal 10a is the low voltage level signal. As the CPU 2 receives the energy-saving signal 10a in FIG. 4, in the duration of the energy-saving signal 10a, the CPU 2 operates between the high operational frequency and the low operational frequency, so as to achieve control of the power consumption of the motherboard 1. In FIG. 4, it can adjust the value of n of the energy-saving signal 10a by Pulse Width Modulation (PWM) to drive the PROCHOT# signal for underclocking control of the CPU 2, so that the power consumption of the CPU 2 varies with a duty cycle of the PWM. A mechanism of frequency dividing for the CPU 2 can result in an average frequency and average power consumption according to the signal which is adjusted by the PWM.

Please refer to FIG. 5 and FIG. 6 with other previous figures. In this embodiment, the energy-saving driving module 100 includes a controller 101 and a level regulator 103. The controller 101 can be an embedded controller, such as a Super Input/Output (SIO) chip on the motherboard 1, or can be an external controller. The controller 101 is for generating the energy-saving signal 10a with the multiple voltage levels. The value of the n can be set and stored in a register, not shown in figures, inside the controller 101, and the controller 101 generates the energy-saving signal 10a according to the value of n stored in the register.

In order to meet a specification requirement of an input voltage level of the PROCHOT# pin, the level regulator 103 is disposed between the controller 101 and the CPU 2. The level regulator 103 is electrically connected to the controller 101 for regulating the voltage level of an energy-saving signal 10′a to meet the specification requirement of the input voltage level of the PROCHOT# pin. The level regulator 103 can be implemented by conventional circuits.

Furthermore, the level regulator 103 is also for receiving an enable signal and further for determining whether to output the regulated energy-saving signal 10a according to the enable signal. The enable signal can be implemented by the PWM to control switching time of the level regulator 103, and the duty cycle of the PWM can be modified to achieve multiple levels of the energy consumption, such as 256 levels.

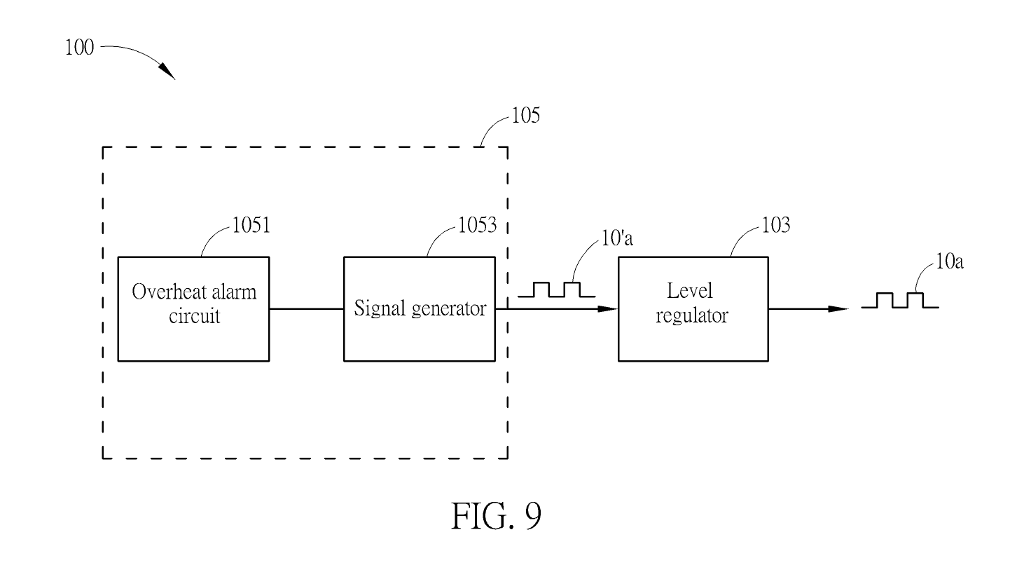

Please refer to FIG. 9 with other previous figures. FIG. 9 is a block diagram of the energy-saving driving module 100 according to another embodiment of the present invention. In this embodiment, the energy-saving driving module 100 includes an overheat alarm circuit module 105 for generating the energy-saving signal 10′a with the multiple voltage levels according to a temperature of the CPU 2 shown in FIG. 1, and the level regulator 103 is electrically connected to the overheat alarm circuit module 105 for regulating the voltage level of the energy-saving signal 10′a. The overheat alarm circuit module 105 includes an overheat alarm circuit 1051 and a signal generator 1053. The overheat alarm circuit 1051 is for detecting the temperature of the CPU 2, and the signal generator 1053 is electrically connected to the overheat alarm circuit 1051 for generating the energy-saving signal 10′a according to a detecting result of the overheat alarm circuit 1051. As the temperature of the CPU 2 rises over a predetermined value, the overheat alarm circuit 1051 controls the signal generator 1053 to generate the energy-saving signal 10′a. The overheat alarm circuit 1051 and the signal generator 1053 can be implemented by the conventional circuits.

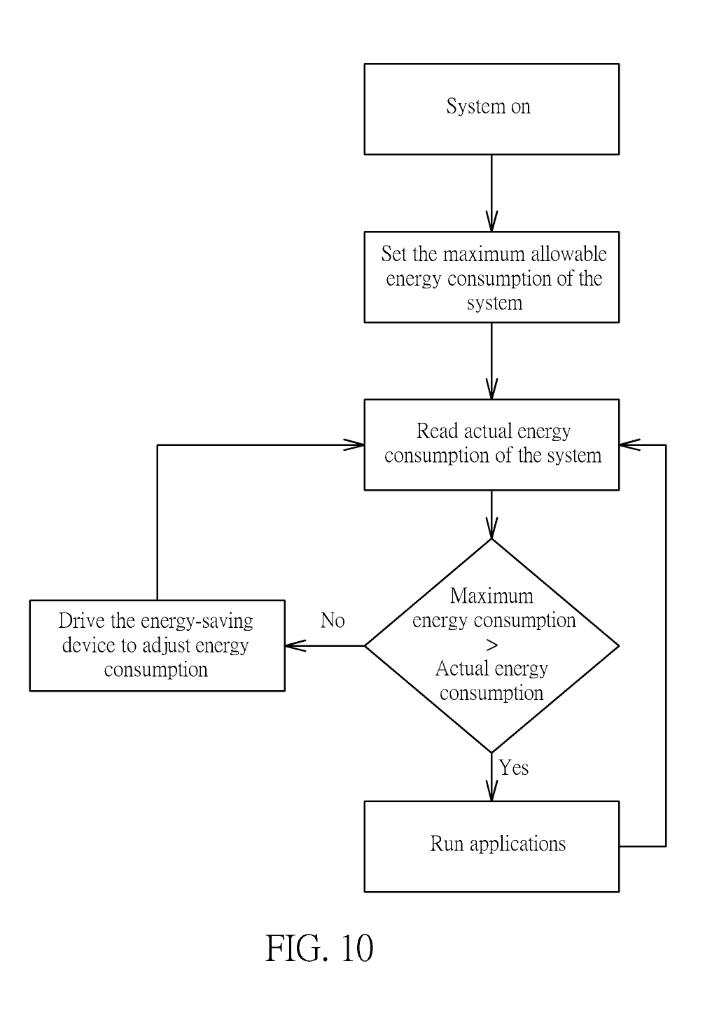

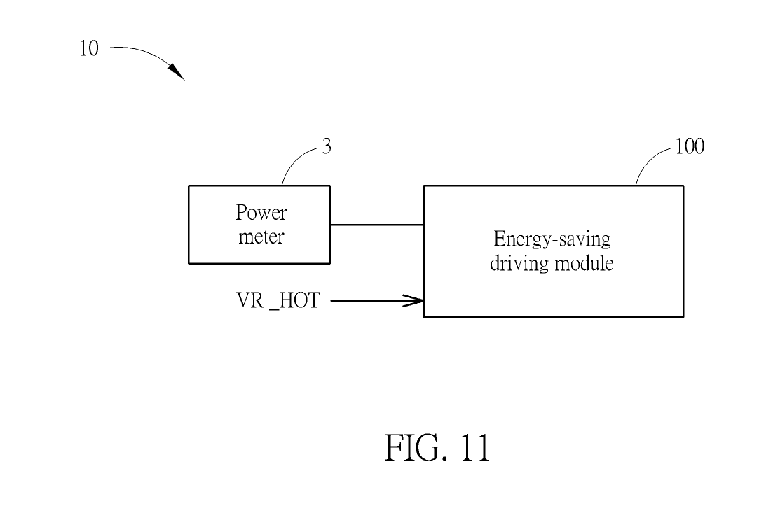

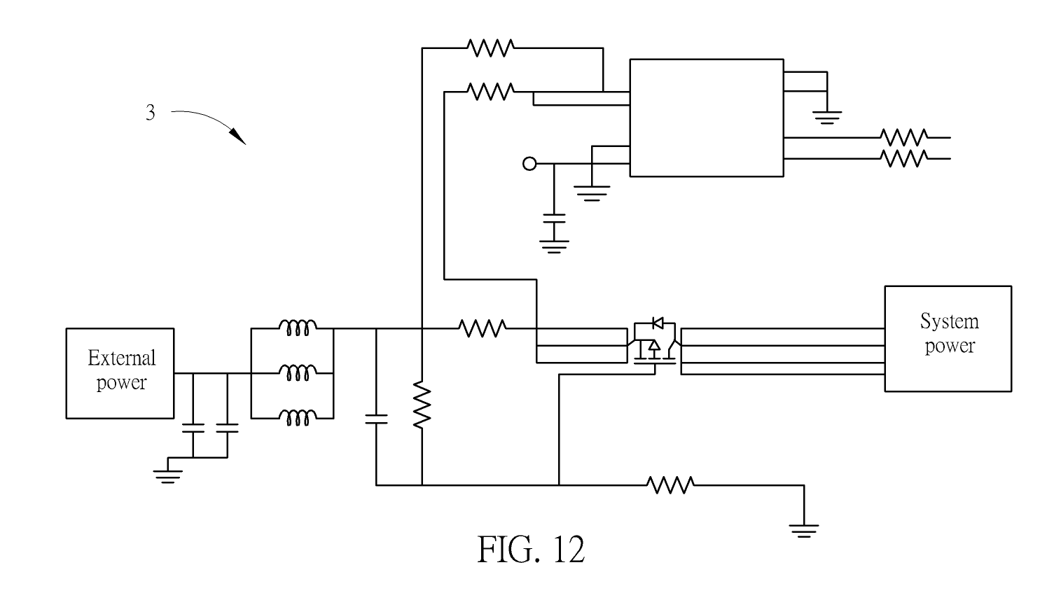

Please refer to FIG. 10 to FIG. 12 with other previous figures. FIG. 10 is a flowchart showing the operation of the energy-saving device 10 according to the embodiment of the present invention. FIG. 11 is a block diagram of the energy-saving device 10 according to another embodiment of the present invention. FIG. 12 is a circuit diagram of a power meter 3 illustrated in FIG. 11 according to another embodiment of the present invention. In this embodiment, the energy-saving device 10 further includes the power meter 3 electrically connected to the energy-saving driving module 100. The power meter 3 is for calculating power consumption of a system with the motherboard 1, an operation system and applications performing with the motherboard 1. By utilizing the power meter 3 with the energy-saving driving module 100, power consumption of the system can be controlled under the maximum power consumption as the system operates. In addition, the energy-saving driving module 100 in FIG. 11 can receive an overheat alarm signal (VR HOT signal), and then can generate the energy-saving signal 10a.

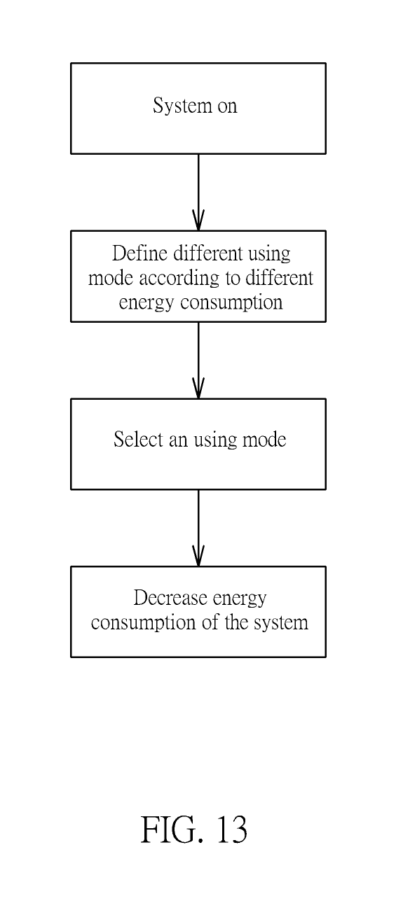

Please refer to FIG. 13 with other previous figures. FIG. 13 is a flowchart showing another operation of the energy-saving device 10 according to the embodiment of the present invention. It can define different using modes with different energy consumption according to different functions and environments, and then users can select one of the using modes, such as an office mode, a multimedia mode, a game mode, and so on. After selection, the system can set the energy-saving device 10 according to the selected using mode. For example, the system can set the value of the n stored in the register inside the controller 101 according to the selected using mode, so as to decrease the power consumption and conform to the selected using mode.

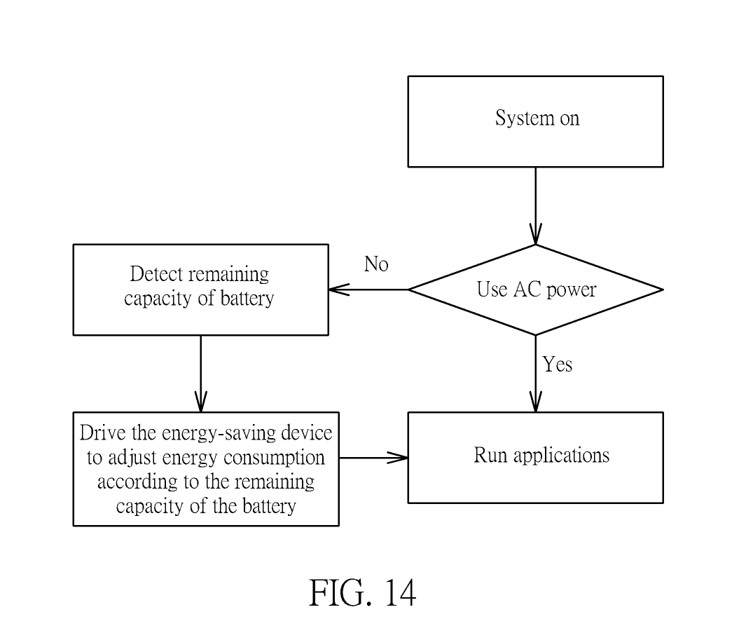

Please refer to FIG. 14 with other previous figures. FIG. 14 is a flowchart showing another operation of the energy-saving device according to the embodiment of the present invention. The energy-saving device 10 can be applied to a mobile electronic device. As the mobile electronic device with the energy-saving device 10 receives an alternating current (AC) power, the PROCHOT# pin of the CPU 2 is not controlled. As the AC power is removed and the mobile electronic device uses a battery, the mobile electronic device enables the energy-saving device 10 according to the remaining capacity of the battery which can be detected by the mobile electronic device. That is, the mobile electronic device can set the value of the n stored in the register inside the controller 101 of the energy-saving device 10 according to the remaining capacity of the battery, to decrease the power consumption and to extend battery life.

In contrast to the prior art, the present invention is to provide the energy-saving device with multiple voltage levels, such as being capable of implementing 256 voltage levels instead of the conventional two voltage levels, so as to achieve multiple power consumption of the motherboard. A purpose of implementing multiple voltage levels can be achieved by the PWM, so as to achieve different power consumption. In addition, the energy-saving device can be applied to a desktop computer, a notebook computer, a tablet computer or other computer device, so as to decrease the power consumption.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An energy-saving device, comprising:
an energy-saving driving module electrically connected to a CPU on a motherboard for generating an energy-saving signal with multiple voltage levels to the CPU, so as to switch the CPU to a corresponding operational frequency according to a voltage level of the energy-saving signal after the CPU receives the energy-saving signal.

2. The energy-saving device of claim 1, wherein the energy-saving driving module comprises:
a controller for generating the energy-saving signal; and
a level regulator electrically connected to the controller for regulating the voltage level of the energy-saving signal.

3. The energy-saving device of claim 2, wherein the level regulator is for receiving an enable signal and further for determining whether to output the regulated energy-saving signal according to the enable signal.

4. The energy-saving device of claim 2, wherein the controller is an embedded controller on the motherboard.

5. The energy-saving device of claim 1, wherein the energy-saving driving module comprises:
an overheat alarm circuit module for generating the energy-saving signal according to a temperature of the CPU; and
a level regulator electrically connected to the overheat alarm circuit module for regulating the voltage level of the energy-saving signal.

6. The energy-saving device of claim 5, wherein the level regulator is for receiving an enable signal and further for determining whether to output the regulated energy-saving signal according to the enable signal.

7. The energy-saving device of claim 5, wherein the overheat alarm circuit module comprises:
an overheat alarm circuit for detecting the temperature of the CPU; and
a signal generator electrically connected to the overheat alarm circuit for generating the energy-saving signal according to a detecting result of the overheat alarm circuit.

8. The energy-saving device of claim 1, further comprising a power meter electrically connected to the energy-saving driving module.

9. The energy-saving device of claim 1, wherein the energy-saving signal corresponds to a low voltage level signal, a high voltage level signal or a signal composed of continuous square waves with an adjustable duty, wherein a ratio of a high voltage level of the continuous square waves to a low voltage level of the continuous square waves is between 0 and 255.

10. The energy-saving device of claim 1, wherein the energy-saving driving module outputs the energy-saving signal to a PROCHOT# pin on the CPU.
